(19) United States
(12) Patent Application Publication
(10) Pub. No.: US 2019/0055108 A1
(43) Pub. Date: Feb. 21, 2019

(54) VARIABLE CROSS-SECTION ELEVATOR GUIDE RAIL CONNECTOR

(71) Applicant: Otis Elevator Company, Farmington, CT (US)

(72) Inventor: Aurelien FAUCONNET, Isdes (FR)

(21) Appl. No.: 16/078,757

(22) PCT Filed: Feb. 24, 2016
(86) PCT No.: PCT/IB2016/000315

§ 371 Date: Aug. 22, 2018

(51) Int. Cl. B66B 7/02; B33Y 80/00

(52) U.S. Cl. CPC B66B 7/026; B33Y 80/00

(57) ABSTRACT

Guide rails connectors and methods of making the same are provided. A guide rail connector (208) includes a base (222) having a first end (232) and a second end (234) and defining a surface therebetween, a blade portion (224) extending from the surface of the base (222) and defining a height from the base (222), wherein a first height at the first end (232) is less than a second height at the second end (234), the blade portion (224) having a constant blade width extending from the first end (232) to the second end (234), a first attachment portion (228) extending from the first end (232) of the base (222), and a second attachment portion (230) extending from the second end (234) of the base (222). The base (222) defines a transitional base (226) relative to the blade portion (224), extending from the first end (232) to the second end (234), wherein the transitional base (226) has a variable cross-section extending from the first end (232) to the second end (234).

### BACKGROUND

The subject matter disclosed herein generally relates to elevator systems and, more particularly, to guide rails having a variable cross-section connector.

Current elevator systems use one type of guide rail to form a guide rail upon which an elevator car and/or counterweight may travel. For proper operation and/or safety, various forces must be considered when designing and constructing an elevator guide rail. Such considerations may require specific guide rail sizing which may impact the total weight and cost of the installation of an elevator system within a building. For example, the taller a building and elevator system is, the stronger the guide rail needs to be. Thus, for taller and/or larger buildings or other structures that include elevator systems, relatively large guide rails may be required to support the weight of the elevator car(s) and/or counterweight(s) and the associated forces generated thereby. On current designs, one size guide rail, i.e., one cross-sectional shape, is used to make a single or whole guide rail track.

### SUMMARY

According to one embodiment, a guide rail connector for an elevator system is provided. The guide rail connector includes a base having a first end and a second end and defining a surface between the first end and the second end, a blade portion extending from the surface of the base and defining a height from the base, wherein a first height at the first end is less than a second height at the second end, the blade portion having a constant blade width extending from the first end to the second end, a first attachment portion extending from the first end of the base, and a second attachment portion extending from the second end of the base. The base defines a transitional base relative to the blade portion, extending from the first end to the second end, wherein the transitional base has a variable cross-section extending from the first end to the second end.

In addition to one or more of the features described above, or as an alternative, further embodiments of the connector may include a first interface defined by a surface of the blade portion at the first end.

In addition to one or more of the features described above, or as an alternative, further embodiments of the connector may include a second interface defined by a surface of the blade portion at the second end.

In addition to one or more of the features described above, or as an alternative, further embodiments of the connector may include that the first interface is configured to match the dimensions of an end of a first guide rail section.

In addition to one or more of the features described above, or as an alternative, further embodiments of the connector may include that the second interface is configured to match the dimensions of an end of a second guide rail section.

In addition to one or more of the features described above, or as an alternative, further embodiments of the connector may include that the first attachment portion is a first flange having at least one aperture therein, the at least one aperture of the first flange configured to receive a fastener.

In addition to one or more of the features described above, or as an alternative, further embodiments of the connector may include that the second attachment portion is a second flange having at least one aperture therein, the at least one aperture of the second flange configured to receive a fastener.

In addition to one or more of the features described above, or as an alternative, further embodiments of the connector may include that the base has a first width at the first end and a second width at the second end, wherein the first width is less than the second width.

In addition to one or more of the features described above, or as an alternative, further embodiments of the connector may include that the first attachment portion has a width equal to the first width and the second attachment portion has a width equal to the second width.

According to another embodiment, a method of manufacturing a guide rail connector for an elevator system is provided. The method includes forming a base having a first end and a second end and defining a surface between the first end and the second end, forming a blade portion extending from the surface of the base and defining a height from the base, wherein a first height at the first end is less than a second height at the second end, the blade portion having a constant blade width extending from the first end to the second end, forming a first attachment portion extending from the first end of the base, and forming a second attachment portion extending from the second end of the base. The base defines a transitional base relative to the blade portion, extending from the first end to the second end, wherein the transitional base has a variable cross-section extending from the first end to the second end.

In addition to one or more of the features described above, or as an alternative, further embodiments of the method may include that at least one aperture is formed in each of the first attachment portion and the second attachment portion.

In addition to one or more of the features described above, or as an alternative, further embodiments of the method may include that the base has a first width at the first end and a second width at the second end and wherein the first width is less than the second width.

In addition to one or more of the features described above, or as an alternative, further embodiments of the method may include that the first attachment portion has a width equal to the first width and the second attachment portion has a width equal to the second width.

In addition to one or more of the features described above, or as an alternative, further embodiments of the method may include that the connector is formed by casting and machining.

In addition to one or more of the features described above, or as an alternative, further embodiments of the method may include that the connector is formed by additive manufacturing.

Technical effects of embodiments of the present disclosure include an elevator guide rail connector that enables the use of different size elevator guide rail sections such that the total weight, size, and cost of the elevator guide rail may be reduced. Further technical effects of embodiments of the present disclosure include a connector that provides a smooth transition from one type or size of elevator guide rail section to another type or size of elevator guide rail section, such that a continuous guide rail blade may be formed within an elevator shaft.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1A is a schematic illustration of an elevator system that may employ various embodiments of the disclosure;

FIG. 1B is a side schematic illustration of an elevator car of FIG. 1A attached to a guide rail track;

FIG. 2A is a side view schematic illustration of an elevator guide rail having an elevator guide rail connector in accordance with an embodiment of the present disclosure;

FIG. 2B is an exploded view of the elevator guide rail connector of FIG. 2A;

FIG. 3 is a side view schematic illustration of an elevator guide rail connector in accordance with an embodiment of the present disclosure;

FIG. 4A is a top plan view of an elevator guide rail connector in accordance with an embodiment of the present disclosure;

FIG. 4B is a bottom plan view of the elevator guide rail connector of FIG. 4A;

FIG. 4C is a front elevation view of the elevator guide rail connector of FIG. 4A;

FIG. 4D is a side view of the elevator guide rail connector of FIG. 4A; and

FIG. 5 is a flow process for manufacturing an elevator guide rail in accordance with an embodiment of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

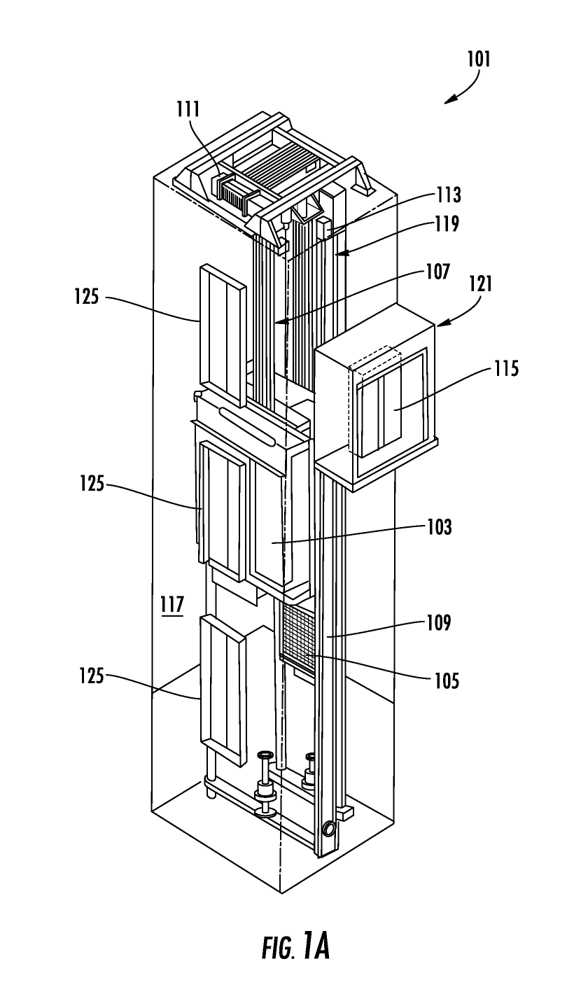

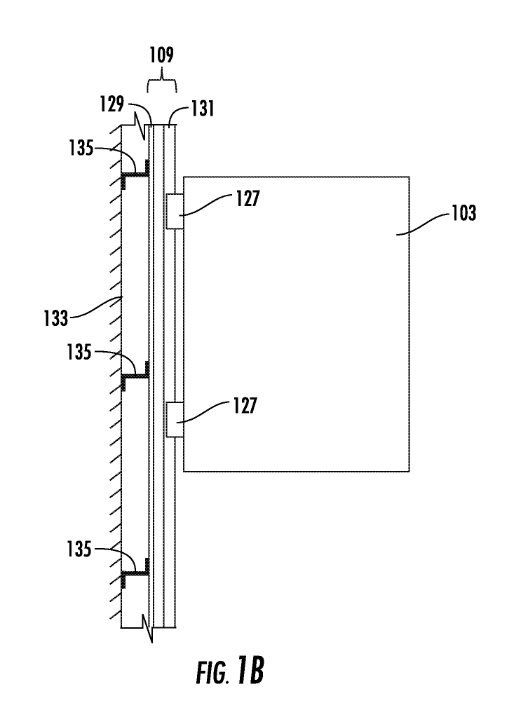

FIG. 1A is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1A is merely a non-limiting example presented for illustrative and explanatory purposes.

FIG. 1B is a side view schematic illustration of the elevator car 103 as operably connected to the guide rail 109. As shown, the elevator car 103 connects to the guide rail 109 by one or more guiding devices 127. The guiding devices 127 may be a guide shoe, a roller, etc. The guide rail 109 defines a guide rail track that has a base 129 and a blade 131 extending therefrom. The guiding devices 127 are configured to run along and/or engage with the blade 131. The guide rail 109 mounts to a wall 133 of the elevator shaft 117 by one or more brackets 135. The brackets 135 are configured to fixedly mount to the wall 133 and the base 129 of the guide rail 109 fixedly attaches to the brackets 135. As will be appreciated by those of skill in the art, a guide rail of a counterweight of an elevator system may be similarly configured.

As provided herein, guide rails having different guide rail sections and a transition section between the different guide rail sections are provided. Each section of the guide rail has the same guide rail blade width, such that elevator movement along the guide rail is not affected. However, advantageously, by allowing different sections having different cross-section on the same guide rail track, an increased guide rail cross section is employed only where needed and “lighter” guide rail sections may be used where possible. For example, a larger and thus heavier cross-section section of guide rail may be used at lower portions within a building, in order to support the weight of the guide rail and the elevator car (and other components) that are above the section of guide rail. However, upper sections of guide rail within an elevator shaft may not need to support as much weight, and thus may have reduced cross-sections and thus be lighter guide rail sections. A junction, connector, or other transition section between two different types (by cross-section) of guide rail sections enables a smooth transition, weight support, and continuous guide rail blade within an elevator shaft.

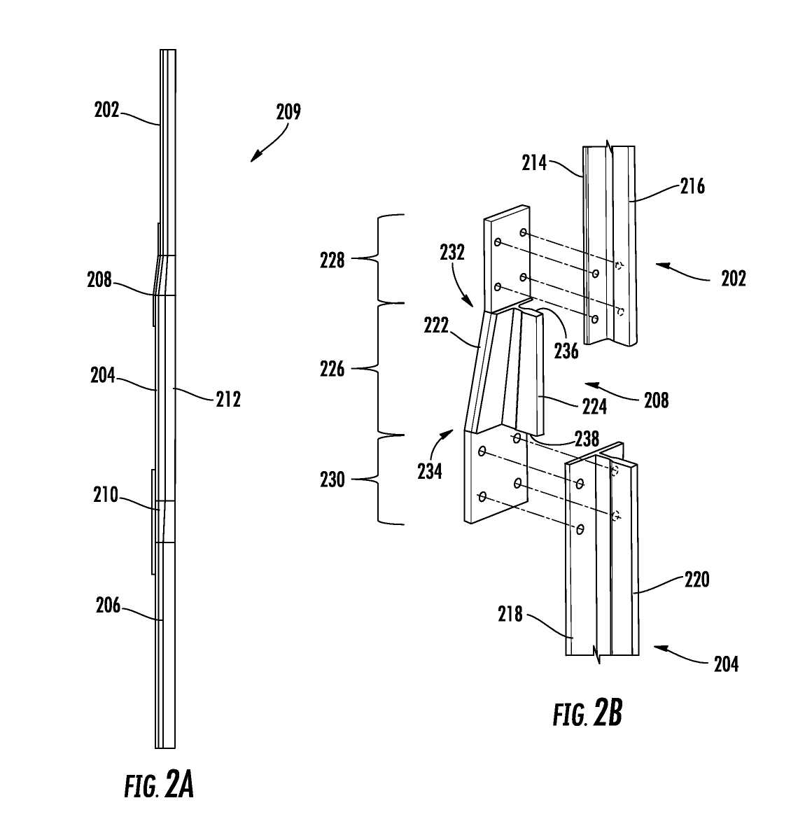

For example, turning now to FIGS. 2A and 2B, a side view schematic illustration and an exploded view of a guide rail track 209 having features in accordance with the present disclosure are shown, respectively. FIG. 2A shows a side view schematic illustration of the guide rail track 209 formed of three separate guide rail sections 202, 204, 206. A first guide rail section 202 forms a top section of the guide rail track 209. A second guide rail section 204 forms a middle section of the guide rail track 209 and is located below the first guide rail section 202, for example when located within an elevator shaft within a building. A third guide rail section 206 is located below the second guide rail section 204 and may form a bottom section of the guide rail track 209. In some configurations, each of the first, second, and third guide rail sections 202, 204, 206 will have different cross-sectional areas, material compositions, etc. depending on the weight that the particular guide rail section is required to carry, or based on other considerations.

As shown in FIG. 2A, a first connector 208 is configured between the first guide rail section 202 and the second guide rail section 204 of the guide rail track 209. A second connector 210 is configured between the second guide rail section 204 and the third guide rail section 206 of the guide rail track 209. The first and second connectors 208, 210 are configured to enable attachment of the sections of the guide rail such that a continuous width guide rail blade 212 is formed and an elevator car and/or counterweight may be configured to move along the guide rail blade 212.

As shown in FIG. 2B, an exploded schematic illustration of the first connector 208 as it attaches to the first and second guide rail sections 202, 204 of the guide rail track 209 is shown. The first guide rail section 202 has a base 214 and a blade portion 216. The blade portion 216 of the first guide rail section 202 extends normal (or perpendicular) from the base 214 of the first guide rail section 202. The blade portion 216 of the first guide rail section 202 forms a portion of the blade 212 of the guide rail track 209.

Similarly, the second guide rail section 204 has a base 218 and a blade portion 220 extending normal (or perpendicular) from the base 218 thereof. The blade portion 220 of the second guide rail section 202 forms a portion of the blade 212 of the guide rail track 209.

Because of different cross-sectional sizes, the first guide rail section 202 and the second guide rail section 204 cannot be joined directly to form the blade 212 of the guide rail track 209. For example, the distance the blade portions 216, 220 extend from the respective bases 214, 218 is different, and thus a smooth transition from the first guide rail section 202 to the second guide rail section 204 may not be possible with a direct connection. Particularly, if the two guide rail sections 202, 204 are attempted to be directly connected, the blade portions 216, 220 must be aligned to enable an elevator car or counterweight to move there along, but in such a configuration, the blade portion 220 of the second guide rail portion 204 would bear the weight of the first guide rail portion 202, which may not be possible. Further, aligning the two bases 214, 218 would enable proper support, but the blade 212 of the guide rail track 209 would not be continuous.

However, the first connector 208 is configured to provide a transition from the first guide rail section 202 to the second guide rail section 204, while maintaining a smooth guide rail blade transition. The first connector 208 includes a base 222 defining a surface and a blade portion 224 extending from the surface of the base 222. The base 222, in some embodiments and as shown in FIGS. 2A, 2B, defines a transition portion 226 extending from a first attachment portion 228 to a second attachment portion 230. The transition portion 226 provides a variable cross-section over a length of the first connector 208, which thus enables a transition from the first guide rail section 202 to the second guide rail section 204. The transition portion 226, as shown, has an inclined, straight, or constant shape. However, those of skill in the art will appreciate that other shapes and/or geometries of the transition portion may be used without departing from the scope of the present disclosure. For example, the transition portion may have a curved, arcuate, elliptical, step-wise, or other shape that provides a variable cross-section extending from one end (e.g., first attachment portion 228) to the other end (e.g., second attachment portion 230).

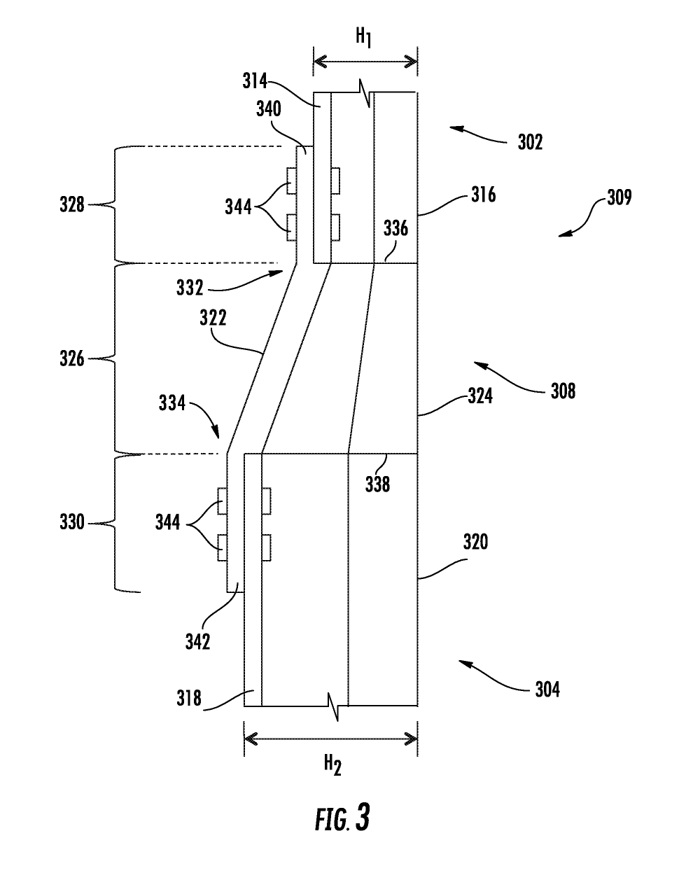

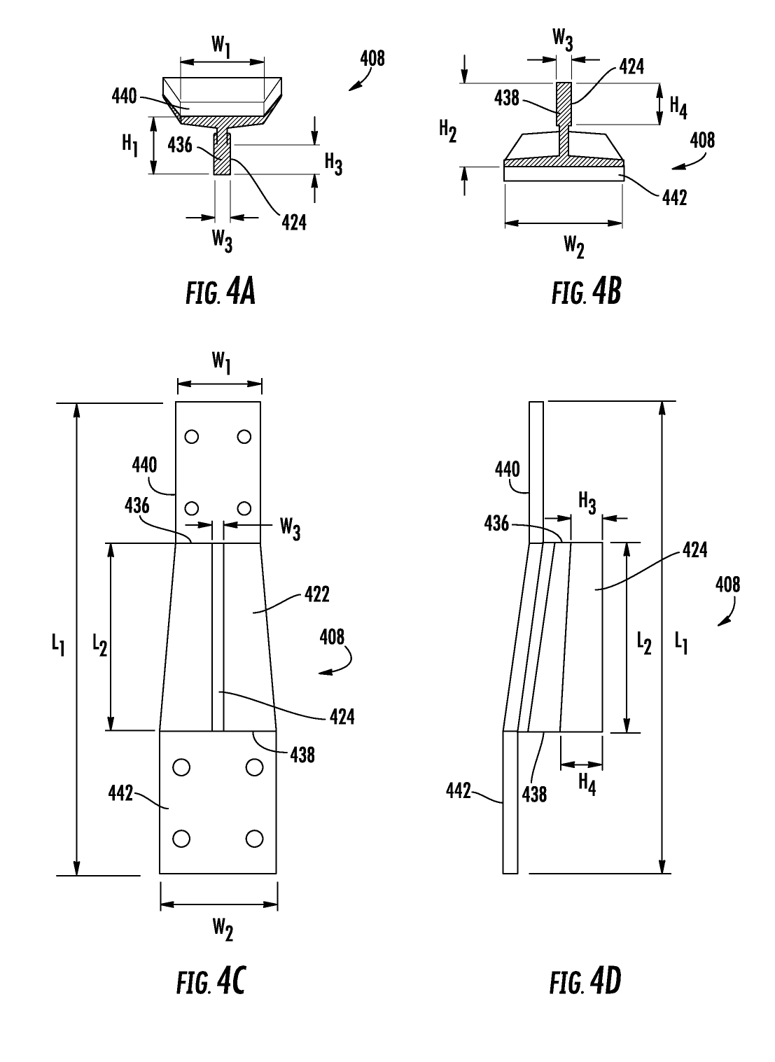

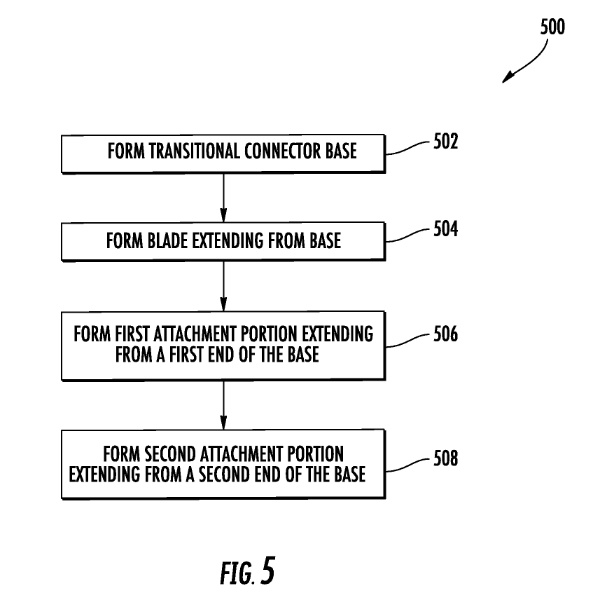

Described in another manner, the transition portion 226 of the first connector 208 has a first end 232 and a second end 234. The transition portion 226 has a first interface 236 at the first end 232 and a second interface 238 at the second end 234 (see, e.g., FIGS. 4A-4D). The first attachment portion 228 extends from the first end 232 and the second attachment portion 230 extends from the second end 234 of the base 222 of the transition portion 226 of the first connector 208.

The first interface 236 is configured to match in shape, geometry, configuration, etc. with an end of the first guide rail portion 202 such that the blade portion 216 of the first guide rail portion 202 and the blade portion 224 of the first connector 208 align and form the continuous guide rail blade 212. Further, the second interface 238 is configured to match in shape, geometry, configuration, etc. with an end of the second guide rail portion 204 such that the blade portion 220 of the second guide rail portion 204 and the blade portion 224 of the first connector 208 align and form the continuous guide rail blade 212.

The first and second attachment portions 228, 230 are configured to rigidly fasten and/or attach to the first and second guide rail sections 202, 204, respectively. That is, the first and second attachment portions 228, 230 are configured to enable attachment between the first connector 208 and the first and second guide rail sections 202, 204. For example, in some embodiments, the first and second attachment portions 228, 230 include apertures to enable screws, bolts, or other fasteners to fixedly attach the first connector 208 to both the first and second guide rail sections 202, 204.

Turning now to FIG. 3, a side view schematic illustration of a guide rail connector in accordance with an embodiment of the present disclosure is shown. In FIG. 3, a connector 308 is positioned between a first guide rail section 302 and a second guide rail section 304. Collectively, the connector 308, the first guide rail section 302, and the second guide rail section 304 form a guide rail track 309 (or a span or length of a guide rail). The first guide rail section 302 includes a base 314 and a blade portion 316, the first guide rail section 302 defining a first height H₁, from base 314 to blade portion 316. The second guide rail section 304 includes a base 318 and a blade portion 320, the second guide rail section 304 defining a second height H₂, from base 318 to blade portion 320.

The connector 308 includes a base 322 and a blade portion 324 extending from the base 322, the base 322 having a first end 332 and a second end 334. Extending from the first end 332 of the base 322 is a first attachment portion 328 and extending form the second end 334 of the base 322 is a second attachment portion 330. The first attachment portion 328, in some embodiments, is a first flange 340, and the second attachment portion 330, in some embodiments, is a second flange 342. As shown, fasteners 344 fixedly connect or attach the first and second flanges 340, 342 to ends of the first guide rail section 302 and the second guide rail section 304, respectively.

The connector 308 further includes a first interface 336 extending from the first end 332 of the base 322 along the blade portion 324 of the connector 308 for a distance equal to the first height H₁ of the first guide rail section 302. Similarly, the connector 308 includes a second interface 338 extending from the second end 334 of the base 322 along the blade portion 324 of the connector 308 for a distance equal to the second height H₂ of the second guide rail section 304. As shown in FIG. 3, the first height H₁ is less than the second height H₂, and thus the base 322 of the connector 302 defines a transition portion 326, and thus the connector 308 has a variable cross-section extending from the first end 332 to the second end 334.

Turning now to FIGS. 4A-4D, various schematic illustrative views of a connector 408 in accordance with an embodiment of the present disclosure are shown. FIG. 4A is a top plan view of the connector 408 facing the first interface 436. FIG. 4B is a bottom plan view of the connector 408 facing the second interface 438. FIG. 4C is a front view of the connector 408. FIG. 4D is a side view of the connector 408.

As shown, the connector 408 includes a base 422 having a blade portion 424 extending therefrom. Further, the connector 408 includes a first flange 440 and a second flange 442 that are configured to enable the connector 408 to rigidly and/or fixedly attach to one or more guide rail portions, as described above.

As shown in FIG. 4A, the first interface 436 has a first width W₁ that is also the width of the first flange 440. The first width W₁ is configured and selected to match with a guide rail portion that will connect to the connector 408 at the first interface 436. The first interface 436 also has a first height H₁, which as described above is the same as a height of a guide rail portion to which the connector 408 will attach. The first interface 436 is configured to support a guide rail portion when a guide rail portion is connected to the first flange 440. The blade portion 424 at the first interface 436 may have a blade dimension with a third height H₃ and a third width W₃. The blade dimension at the first interface 436 is configured to match the geometry of a blade dimension of a blade on a guide rail portion that attaches and connects to the connector 408 at the first interface 436.

As shown in FIG. 4B, the second interface 438 has a second width W₂ that is also the width of the second flange 442. The second width W₂ is configured and selected to match with a guide rail portion that will connect to the connector 408 at the second interface 438. The second interface 438 also has a second height H₂, which as described above is the same as a height of a guide rail portion to which the connector 408 will attach. The second interface 438 is configured to support the connector 408 on a guide rail portion when a guide rail portion is connected to the second flange 442. The blade portion 424 at the second interface 438 may have a blade dimension with a fourth height H₄ and has the same width, e.g., the third width W₃, as at the first interface 436. The blade dimension at the second interface 438 is configured to match the geometry of a blade dimension of a blade on a guide rail portion that attaches and connects to the connector 408 at the second interface 438.

In a length direction, as shown in FIGS. 4C and 4D, the connector 408 has a first length L₁ with the base 422 and blade portion 424 having a second length L₂ that is less than the first length L₁. This results in the base 422 of the connector 408 transitioning, e.g., inclining, from the first interface 436 to the second interface 438, as show in FIG. 4D. The first length L₁ is a length from an end of the first flange 440 to an end of the second flange 442. The second length L₂ is a length of the base 422 having the blade portion 424.

In a width direction, as shown in FIGS. 4C and 4D, the base 422 of the connector 408 widens from the first interface 436, having a width of the first width W₁, to the second interface 438, having a width of the second width W₂. However, as shown in FIG. 4C, the width of the blade portion 424 stays constant at the third width W₃.

In a height direction, as shown in FIGS. 4A, 4B, and 4D, the height of the connector 408 increases from the first interface 436 (first height H₁) to the second interface 438 (second height H₂). Further, the blade of the blade portion 424, as shown, is configured with a variable height. That is, on the first interface 436, the blade has a third height H₃, which is a portion of the first height H₁ of the first interface 436. Similarly, on the second interface 438, the blade has a fourth height H₄, which is a portion of the second height H₂ of the second interface 438. Accordingly, the blade of the blade portion of an entire connected guide rail track may have a transition in the blade portion in addition to the base portions thereof.

Turning now to FIG. 5, a flow process for making a connector for an elevator guide rail in accordance with an embodiment of the present disclosure is shown. The flow process 500 may be used to form a connector as shown and described above and/or variations thereon.

A base is formed, as shown at block 502, with the base having a transitional shaped, including but not limited to inclined, tapered, curved, elliptical, arcuate, etc. surfaces. A blade is formed extending from a surface of the base, as shown at block 504. At block 506, a first attachment portion is formed on a first end of the base, and at block 508, a second attachment portion is formed on a second end of the base. In some embodiments, each of the elements of the flow process 500 may be performed simultaneously or nearly simultaneously. For example, various features of the connector, as shown and described herein, may be casted and then machined. In other embodiments, the connector may be additively manufactured, as known in the art. Other manufacturing techniques may be used without departing from the scope of the present disclosure.

Advantageously, embodiments provided herein enable use of different guide rail sections (each section having the same guide rail blade width) on the same guide rail track in order to increase the section of the guide rail only where it is needed. Further, advantageously, relatively “lighter” guide rail sections may be used on the top of the hoist way, where increased guide rail size is not required. The junction between two different types of guide rail sections is achieved with embodiments provided herein.

Further, advantageously, cost reduction may be achieved by employing embodiments provided herein, especially for mid- and high-rise structures (and associated elevator shafts) as lighter guide rail sections may be used on the top and/or upper portions of the guide rail track. For example, above a certain limit of rise, the weight of the guide rail track and width of the guide rail must be increased to accommodate the increased weight and forces of a taller or higher building/structure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

For example, although described with a particular structural configuration, those of skill in the art will appreciate that the geometry of the connectors, as provided herein, may be varied or different without departing from the scope of the present disclosure. Further, although described with respect to a roped elevator system, those of skill in the art will appreciate that elevator guide rails may incorporate features of embodiments described herein in any type of elevator system, without departing from the scope of the present disclosure.

Accordingly, the present disclosure is not to be seen as limited by the foregoing description, but is only limited by the scope of the appended claims.

1. A guide rail connector for an elevator system comprising:
a base having a first end and a second end and defining a surface between the first end and the second end;
a blade portion extending from the surface of the base and defining a height from the base, wherein a first height at the first end is less than a second height at the second end, the blade portion having a constant blade width extending from the first end to the second end;
a first attachment portion extending from the first end of the base; and
a second attachment portion extending from the second end of the base,
wherein the base defines a transitional base relative to the blade portion, extending from the first end to the second end, wherein the transitional base has a variable cross-section extending from the first end to the second end.

2. The connector of claim 1, further comprising a first interface defined by a surface of the blade portion at the first end.

3. The connector of claim 1, further comprising a second interface defined by a surface of the blade portion at the second end.

4. The connector of claim 1, wherein the first interface is configured to match the dimensions of an end of a first guide rail section.

5. The connector of claim 3, wherein the second interface is configured to match the dimensions of an end of a second guide rail section.

6. The connector of claim 1, wherein the first attachment portion is a first flange having at least one aperture therein, the at least one aperture of the first flange configured to receive a fastener.

7. The connector of claim 1, wherein the second attachment portion is a second flange having at least one aperture therein, the at least one aperture of the second flange configured to receive a fastener.

8. The connector of claim 1, wherein the base has a first width at the first end and a second width at the second end, wherein the first width is less than the second width.

9. The connector of claim 8, wherein the first attachment portion has a width equal to the first width and the second attachment portion has a width equal to the second width.

10. A method of manufacturing a guide rail connector for an elevator system comprising:
forming a base having a first end and a second end and defining a surface between the first end and the second end;
forming a blade portion extending from the surface of the base and defining a height from the base, wherein a first height at the first end is less than a second height at the second end, the blade portion having a constant blade width extending from the first end to the second end;
forming a first attachment portion extending from the first end of the base; and
forming a second attachment portion extending from the second end of the base,
wherein the base defines a transitional base relative to the blade portion, extending from the first end to the second end, wherein the transitional base has a variable cross-section extending from the first end to the second end.

11. The method of claim 10, wherein at least one aperture is formed in each of the first attachment portion and the second attachment portion.

12. The method of claim 10, wherein the base has a first width at the first end and a second width at the second end and wherein the first width is less than the second width.

13. The method of claim 12, wherein the first attachment portion has a width equal to the first width and the second attachment portion has a width equal to the second width.

14. The method of claim 10, wherein the connector is formed by casting and machining.

15. The method of claim 10, wherein the connector is formed by additive manufacturing.
